(19) United States
(12) Patent Application Publication
(10) Pub. No.: US 2007/0169681 A1
(43) Pub. Date: Jul. 26, 2007

(54) Wrist flag device

(76) Inventor: Randy Boyd, Milwaukee, WI (US)

Correspondence Address: GLEN E. SCHUMANN;C/O MOSS & BARNETT, 90 SOUTH SEVENTH STREET, 4800 WELLS FARGO CENTER, MINNEAPOLIS, MN, 55402-4129, US

(21) Appl. No.: 11/336,676

(22) Filed: Jan. 20, 2006

(51) Int. Cl. G09F 17/00

(52) U.S. Cl. 116/173

(57) ABSTRACT

A flag connected to a wristband or similar device by a length of material. The wristband and the length of material permit a spectator to throw the flag in a direction away from the spectator without fear of it being lost. The length of material permits the spectator to easily retrieve the flag after it is thrown. The ability to throw the flag increases its visibility and can be used to indicate to a game official a missed infraction. The length of material also allows the spectator to spin the flag around to show the spectator's admiration for the team or game.

### BACKGROUND OF THE INVENTION

1. Field of the Invention

The example embodiment(s) of the invention described herein relate to the field of toys and/or novelty items and particularly pertain to a flag attached to a wrist band by a length of material for utilization during a sporting event.

2. Description of the Related Art

The use of flags at sporting events and the like is readily known. These flags are often handed out to spectators entering a stadium or ballpark. The flags usually have team names and logos fashioned thereon or other types of advertisement for sponsors. During games it is not uncommon for the spectators in the excitement of the moment to throw the flag in the air. Unfortunately, due to the physical characteristics of the flag it is all too common that a spectator is unable to retrieve the flag once it is thrown. This can be particularly troublesome years later when the spectator learns that the flag has become a collector's item.

One inventor, Gregory Mathews, the applicant of U.S. Pat. No. 4,850,052 attempted to resolve this problem. Mathews invented a glove that has a pocket for holding a flag or piece of cloth. During the game a spectator removes a portion of the cloth from the pocket and attaches it to fasteners disposed on the finger tips of the glove. In this fashion the cloth is spread out over the palm of the glove. The spectator can then use their hand to indicate a rule infraction that may or may not have been missed by a game official. Several shortcomings of the device disclosed by Mathews are readily apparent. For instance, in the summer the spectator's hand will sweat making wearing the glove uncomfortable. In the winter the glove may not provide enough warmth to keep the spectator's hand warm if the game is conducted outdoors. Additionally, the glove can hinder a spectator's ability to retrieve items from a pocket or purse to purchase food or memorabilia. Lastly, a significant shortcoming of the Mathews device is that the flag is kept close to the spectator's hand thereby limiting the ability of a game official of seeing it.

Woolery, the applicant of U.S. Pat. No. 1,670,176 invented a signal that consisted of a flag attached to a glove or partial glove for signaling while driving a vehicle. The Woolery device has the same shortcomings as the Mathews, increased heat in the summer; not enough warmth in the winter; and a flag that is kept too close to the user's hand.

What is needed is a flag that can be thrown a distance away from the spectator and easily retrieved. What is also needed is a flag that it is easily visible to the referees, athletes and other spectators. Another unfulfilled need is a flag that is comfortable to wear and permits free movement of the spectator. All of these and other needs are fulfilled by the present invention and will become readily apparent upon examination of the brief summary of the invention, drawings and detailed description.

### BRIEF SUMMARY OF THE INVENTION

The invention pertains to a flag or sheet of material fashioned as a flag that is connected to a wristband or similar device by a length of material. The wristband and the length of material permit a spectator to throw the flag in a direction away from the spectator without fear of it being lost. In one example embodiment, an attachment member is disposed between and connected to the length of material and the flag such that the user can select one of a plurality of flags to use. Additionally, it permits a spectator to use multiple flags.

An advantage of the invention over the prior art is that it can be thrown a distance away from the spectator thereby increasing its visibility.

Another advantage of the invention is that permits the spectator to be more involved in the game. For instance, if the spectator believes there was an infraction that was not seen or called by an official, the spectator can throw the flag into the air as should have been done by the official. This allows the spectator to demonstrate their frustration toward the official.

Another advantage of the invention is that the flag can be spun around above the spectator to show the participants of the game their admiration. Since the flag is attached to the length of material there is no fear that it may be lost.

These and other advantages of the invention will become more fully apparent from the following brief description of the drawings, detailed description of the invention and the appended claims.

### BRIEF DESCRIPTION OF THE DRAWINGS

FIG. 1 is a perspective view of one embodiment of the wrist flag device.

FIG. 2 is a perspective view of one embodiment of the wristband of the wrist flag device.

FIG. 3 is a perspective view of one embodiment of the flag of the wrist flag device

FIG. 4 is a perspective view of one embodiment of the flag of the wrist flag device.

The preceding figures are for illustrative purposes only. Therefore, they should not be considered limiting but rather samples of example embodiments of the invention.

### DETAILED DESCRIPTION OF THE INVENTION

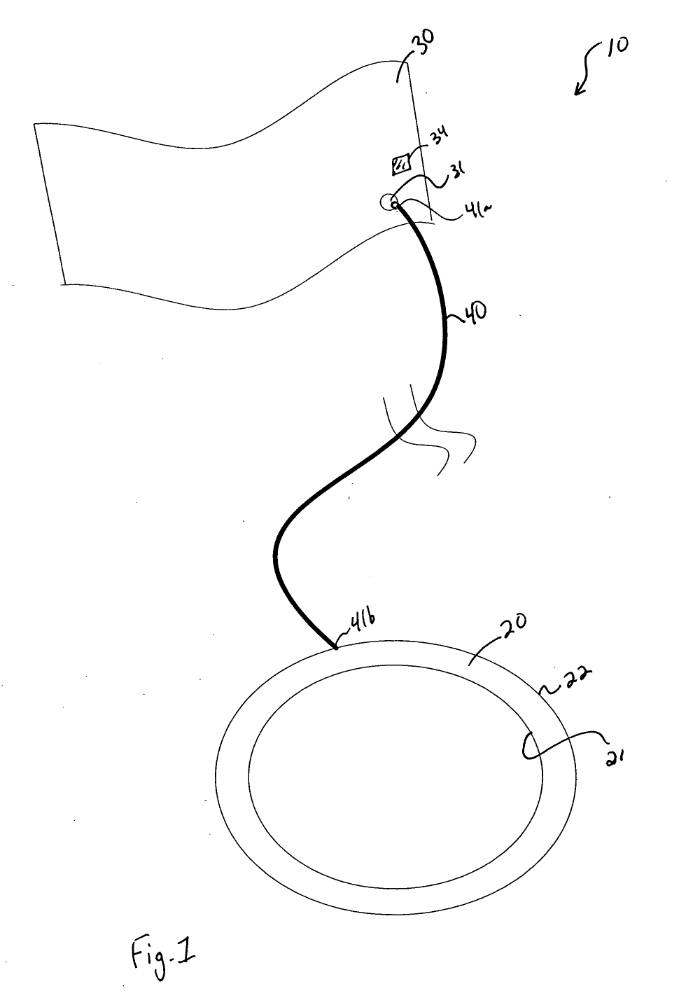

Referring to appended example FIGS. 1-4, an embodiment of a wrist flag device is indicated by numeral 10. In an example embodiment, the device 10 includes a wristband 20 and a flag or sheet of material 30 connected together by a length of material or tether 40.

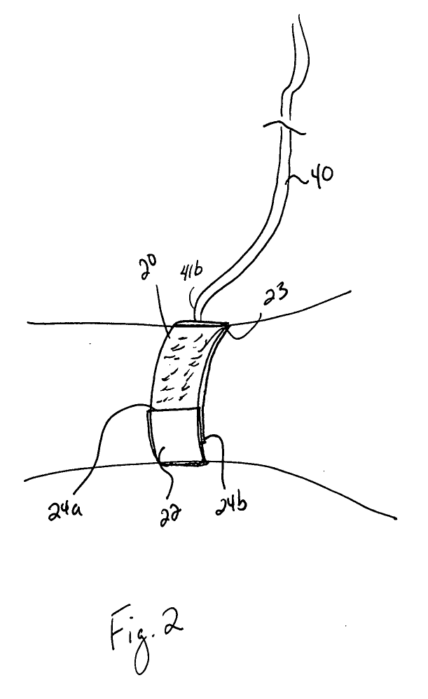

Referring to FIGS. 1 and 2, wristband 20 includes a sheet of material such as nylon webbing and the like having opposed first 21 and second 22 surfaces with the first opposed surface 21 being disposable adjacent a spectator's wrist. The wristband 20 can include a fastening mechanism 23 such as snaps, hook and loop fasteners and the like that are readily known to those skilled in the art. In one example embodiment, wristband 20 includes two opposed ends indicated by numerals 24a and 24b of FIG. 2. The use of the fastening means 23 in conjunction with the opposed ends 24a and 24b permit wristband 20 to be adjustable about a wrist of a spectator.

In another embodiment, wristband 20 can comprise a solid strip of material that can be manufactured from an elastomeric material. This embodiment permits a spectator to stretch the wristband 20 over the hand and onto the wrist. In yet another embodiment of the invention, wristband 20 can comprise a solid or generally rigid ring that fits over the spectator's hand and wrist. Other embodiments and modifications are possible and should be considered to be within the spirit and scope of the invention.

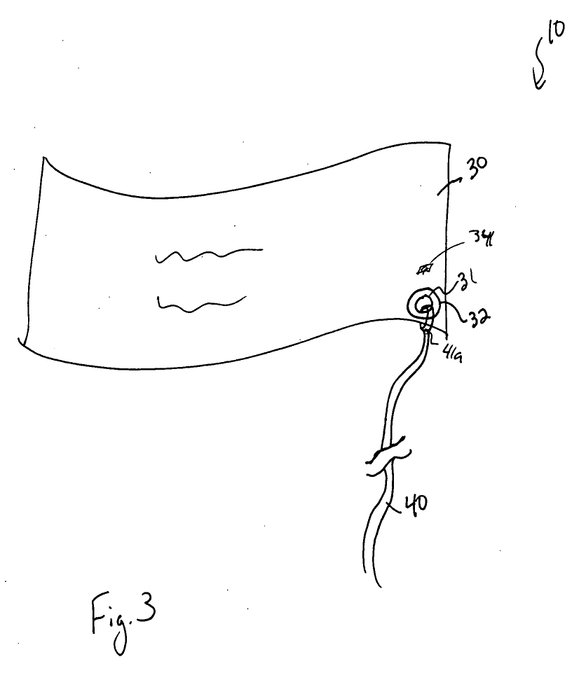

Referring to FIGS. 1 and 3, flag 30 comprises any type of sheet material such as nylon, cotton, synthetic blends and the like. In one example embodiment, a hole 31 is formed in a lower corner of flag 30 for receiving and securing at least a portion of tether 40 therein. Although illustrated in a corner of the flag 30, the hole 31 can be disposed through any portion of the flag 30. Additionally, other types of attachment mechanisms are also possible such as hook and loops, snap fasteners, rings and the like and should be considered to be within the spirit and scope of the invention.

Referring particularly to FIG. 3, a reinforcement ring 32 can be attached to the hole 31 to prevent damage to the flag 30 from attachment to tether 40. The reinforcement ring 32 can be manufactured from plastic, foam, metal or the like so long as it reinforces the material of the flag 30 bordering or forming the hole 31.

Referring to FIGS. 1, 3 and 4, a fastening member 34 can be attached, coupled, connected and the like to a portion of the flag 30 to fasten the flag 30 to a portion of the wristband 20. The fastening member 34 can comprise one half of a hook and loop fastener, half of a snap fastener where the other half of the fastener is secured to the wristband or some other article of clothing of the spectator. In the embodiment having a wristband 20, comprised of a cooperating hooks and loops, the fastening member 34 can be removably coupled to a portion of the wristband 20 until it is to be used by the spectator. This prevents the flag from interfering with the movement of the spectator.

The flag 30 can be manufactured in any shape, size, and color. In one example embodiment, advertisements, team logos and the like can be disposed on the flag 30 by any means. In one of the preferred embodiments the flag 30 is manufactured from a yellow material similar to that of officials of sporting events.

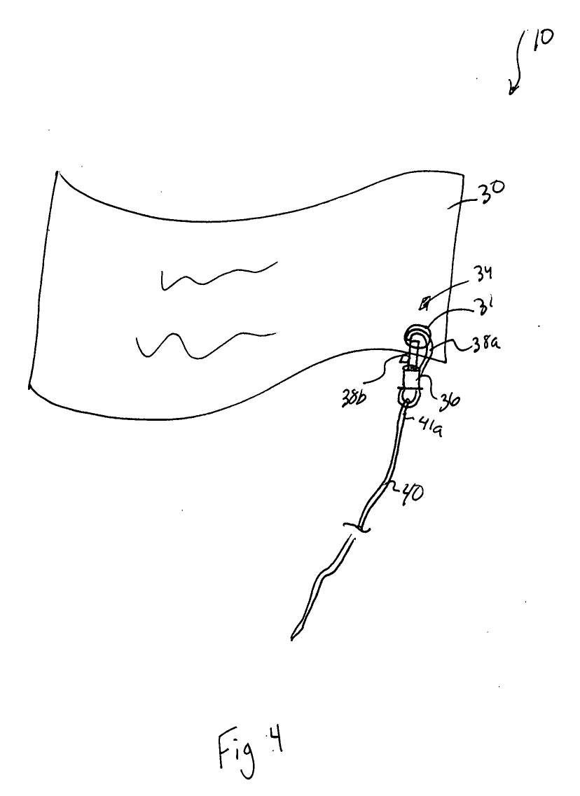

Referring now to FIG. 4, an attachment member 36 can be operatively coupled between the flag 30 and the tether 40. The attachment member 36 can comprise a hook 38a and retractable or pivotable post 38b operatively coupled together to permit a spectator to replace, change, interchange and the like different flags 30. In one embodiment, the hook 38a is extendable through the hole 31 and the post 38b is allow to engage the hook 38a and prevent its detachment from the flag 30.

The attachment member 36 can be manufacture from any material such as plastic and the like. In one embodiment, the attachment member can be manufactured from or coated with a foam material such that it will not damage anything that it comes into contact with during use. For the true sport enthusiast, the attachment member 36 allows them to change flags 30 depending upon the event they are seeing such as, a football, basketball, or hockey game. Other events are also possible and should be considered to be within the spirit and scope of the invention.

The tether 40 connecting the wristband 20 and the 30 flag preferably has a length that permits the spectator to throw the flag 30 into the air and easily retrieve it. It can be manufactured from any material such as rope, twine, cord, an elastic band, and the like. In one embodiment of the invention, the tether 40 can be detached from either or both of the flag 30 and the wristband 20 such that it can be replaced. Cooperative hook and loop fasteners can be used to hook ends 41a and 41b of the tether 40 to the flag 30 and the wristband 20 respectively. Other types of fasteners can also be used to removably secure or attach the tether 40 to the flag 30 and/or wristband 20. In one embodiment, the tether 40 can be manufactured to have the same color or material as the flag 30. It is possible to have tethers 40 that are decorative and/or include logos, advertisements and the like. Other embodiment and modifications are also possible and should be considered to be within the spirit and scope of the invention.

In use a spectator places the wristband 20 around their wrist. Whenever the spectator is moved he or she may throw the flag 30 into the air. The flag 30 can then be retrieved by lifting the arm or pulling on the tether 40. The user may throw the flag 30 into the air to draw the official's attention to a missed infraction during the game. The spectator can also spin or twirl the flag 30 in the air above them while holding the tether 40. This may be done to demonstrate the spectator's appreciation of an event during the game such as a touchdown, basket, homerun or a goal.

When not in use the spectator can wrap the tether 40 around their arm and secure the fastening member 34 to the wristband 20. In another embodiment, the spectator can remove the tether 40 from the wristband 20 and store the flag 30 and attachment member 40 in a pocket or the like. Other uses for the device 10 are also possible and modifications in use should be considered to be within the spirit and scope of the invention.

What is claimed is:

1. A wrist flag device for a wrist of user, the device comprising:
a wrist attachment having opposed surfaces, wherein at least one of the opposed surfaces is disposable against the wrist of the user;
at least one flag; and
a tether having a first end attached to the wrist attachment and a second end attached to the flag.

2. The device of claim 1, wherein the wrist attachment comprises a web material adjustable to the wrist of the user.

3. The device of claim 1, wherein the wrist attachment has a first end and a second end, wherein the first and second ends are cooperatively connectable.

4. The device of claim 1, wherein a hole extends through a portion of the flag for receiving and securing a portion of the tether.

5. The device of claim 4 further comprising a ring dispose about the hole to reinforce the flag.

6. The device of claim 1 further comprising an attachment member operatively coupled between the flag and the tether.

7. The device of claim 6, wherein the attachment member includes a hook portion and a post portion, wherein the hook and post portions are operatively engaged with each other to prevent detachment with the flag.

8. The device of claim 7 further comprising a ring attached about the hole of the flag to engage the attachment member.

9. A wrist flag device for a user, the device comprising:
at least one flag; and
at least one tether having a first end attachable to a portion of the flag and a second end attachable to a user such that a user can throw the at least one flag into the air without losing it.

10. The device of claim 9, wherein the second end of the tether is removably secured about a wrist of a user.

11. The device of claim 9 further comprising a wristband securable about a wrist of a user, wherein the second end of the tether is secured to a portion of the wristband.

12. The device of claim 9 further comprising an attachment member operatively disposed between the first end of the tether and the flag.

13. The device of claim 12, wherein the attachment member includes a hook portion and a post portion, wherein the hook and post portions are operatively engaged with each other to prevent detachment with the flag.

14. The device of claim 9, wherein the flag includes a hole extending therethrough for receiving and securing therein at least a portion of the tether.

15. The device of claim 14, further includes an attachment member securable to at least a portion of the hole.

16. The device of claim 15, wherein the attachment member includes a hook portion and a post portion, wherein the hook and post portions are operatively engaged with each other to prevent detachment with the flag.

17. A method of indicating an infraction during an event, comprising the steps of:
providing at least one flag;
attaching a wristband to a wrist of a user;
having the user hold onto at least a portion of the at least one flag;
attaching a tether between the wristband and the flag; and
having the user throw the at least one flag when an infraction is observed.

18. The method of claim 17, wherein attaching the wristband to a wrist of a user includes detachably fastening a first end and a second end of the wristband together.

19. The method of claim 17 further includes the step of retrieving the flag by pulling on the tether.
